(19) United States
(12) Patent Application Publication
(10) Pub. No.: US 2004/0241284 A1
(43) Pub. Date: Dec. 2, 2004

(54) Method for producing transglutaminase-cross-linked proteins of vegetable origin, protein gels and the use thereof

(76) Inventors: Christian Schaefer, Rheinfelden (DE); Elger Funda, Grenzach-Wyhlen (DE)

Correspondence Address: D Edward Dolgorukov, Marshall & Melhorn, 8th Floor, Four Seagate, Toledo, OH, 43604, US

(21) Appl. No.: 10/487,297

(22) PCT Filed: Oct. 22, 2001
(86) PCT No.: PCT/EP01/12162

(30) Foreign Application Priority Data
Aug. 22, 2001 (DE) 10141166.9

(51) Int. Cl. A23K 1/00

(52) U.S. Cl. 426/52

(57) ABSTRACT

The invention relates to a method for producing transglutaminase-cross-linked proteins of vegetable origin, in which a fractionation of a protein extract, protein curd, protein concentrate, protein hydrolysate and/or protein isolate is carried out by centrifugation and/or ultrafiltration and/or regeneration, and subsequently a cross-linking with transglutaminase takes place at a temperature of between 0 and 60° C. and a mass ratio of between 0.01 and 10%. The invention relates also to a protein gel.

The invention relates to a method for producing transglutaminase-cross-linked proteins of vegetable origin as well as shape-retaining protein gels having a low proportion of dry substance.

In the food industry there is a need in many areas for additives which provide texture. These give the product structure, strength and the way it feels in the mouth. Moreover water contained in the product should be bound in a stable manner and syneresis, i.e. emergence of the water, should be prevented. The aim is frequently the binding of as high as possible a water content in a solid structure. Fields of application are for example meat and sausage products, desserts, sweets, confectionery or ice creams.

To produce solid, texture-providing structures in food, currently gelatine or hydrocolloids are used as additives. However as a product of animal origin gelatine is frequently undesired. Therefore there is a need to replace gelatine by products of vegetable origin.

For the purpose of water binding, polysaccharides and polysaccharide derivatives such as starch, guar seed flour, carob seed meal, carboxymethylcellulose, xanthene etc. are used. However these substances have to be declared and are undesired for reasons of consumer acceptance. Therefore replacement of these substances by more unproblematic substances is sought.

The cross-linking of proteins with transglutaminase is described for numerous applications. These mainly involve the cross-linking of proteins of animal origin, such as meat, fish, milk protein or whey protein. The cross-linking of vegetable proteins is only described for a few applications.

U.S. Pat. No. 5,055,310 describes the production of a tofu which is produced from soya protein and is stable in storage. For this purpose, “soya milk”, which is made from whole soya beans and has a protein content of 3 to 10%, is cross-linked with microbial transglutaminase. An improved texture by comparison with the conventionally produced product is described.

Patent EP 870 434 describes the production of noodles from wheat or buckwheat flour with cross-linking by transglutaminase. The products obtained are distinguished by particular elasticity and sensory properties.

From the literature it is known that the cross-linkability of proteins by transglutaminase depends on the protein source. Moreover individual protein fractions from the same protein source differ in their cross-linkability. Whilst for example Na-caseinate can be cross-linked very well with transglutaminase, the reactivity of α-lactalbumin and of β-lactoglobulin depends on the reaction conditions. Corresponding tests exist for 7S- and 11S-globulin from soya protein. Obtaining protein fractions on an industrial scale for the food industry is not economic however and is therefore generally not carried out.

What is common to the products produced according to the prior art and based on plant proteins is that relatively high protein contents or additional stabilisers are necessary to produce shape-retaining structures.

Proceeding from these disadvantages of the prior art, the object of the present invention was to make available protein products which render possible the production of shape-retaining structures with a simultaneously low proportion of dry substance.

This object is accomplished in respect of the method by the features of claim 1 and in respect of the protein gel by the features of claim 9. The use of the protein gels is described according to claim 12. The additional dependent claims show advantageous developments of the subject matter of the invention.

According to the invention, a method for producing transglutaminase-cross-linked proteins is provided which is based on the following steps:

a) fractionation of a protein extract, protein curd, protein concentrate, protein hydrolysate and/or protein isolate by centrifugation and/or ultrafiltration and/or regeneration.

b) subsequent cross-linking of the proteins with transglutaminase at a temperature of between 0 and 60° C. Here the mass fraction of the transglutaminase is between 0.01 and 10% by weight.

Surprisingly it could now be demonstrated that with the exclusive use of proteins of vegetable origin, high dimensional stability of the protein products cross-linked with transglutaminase could be achieved. As vegetable products, those obtained from proteinaceous and oleaginous seeds were used by preference.

In an advantageous embodiment of the method, before the fractionation in step a), the protein extract was produced from proteinaceous and oleaginous seeds. It is also preferred that after the fractionation in step a), drying of the protein extract, protein curd, protein concentrate, protein hydrolysate and/or protein isolate takes place. Then the protein extract is preferably dissolved in an aqueous solution, including e.g. water, a buffer solution or a saline.

The fractionation is preferably carried out by centrifugation in an aqueous system, e.g. water, buffer solution or saline.

The cross-linking of the proteins with the transglutaminase is preferably carried out at a temperature of between 30 and 50° C. The pH value of the solution in the cross-linking with transglutaminase in step b) is here preferably between 4 and 9, by particular preference between 6 and 7.

By preference, the protein extract used for the cross-linking with the transglutaminase has a dry mass of between 1 and 10% by weight and by particular preference between 3 and 5% by weight.

According to the invention, protein gels are likewise prepared which are produced by cross-linking fractionated protein. of vegetable origin with transglutaminase. These protein gels are distinguished by the low protein content of between 1 and 18% by weight.

In this process, protein gels having two different protein content ranges can be distinguished. Thus protein gels which have a protein content of between 1.5 and 5% by weight have a cut-resistant consistency. These gels are distinguished by a gel strength of between 4 and 8 N/cm². Alternatively, protein gels which have a bite-resistant consistency can also be produced. In these protein gels the protein content is between 10 and 18% by weight, with a gel strength of more than 8 N/cm².

Preferably the protein gel in the dried state has a water binding capacity of between 5 and 20 ml/g, preferably between 10 and 15 ml/g.

Surprisingly, the protein gels according to the invention showed no structural alterations during temperature treatments such as are current in the production and processing of food. Thus the gel structure is preserved at temperature treatments of up to 100° C., but also even up to 120° C.

The protein gels according to the invention are used above all in the production and/or processing of food. This includes for example the production of meat and sausage products, desserts, sweets, confectionery and ice creams.

The method according to the invention will be explained in greater detail with the aid of the following example, without restricting this method to the parameters mentioned herein.

### EXAMPLE

Production of a protein gel according to the invention.

In a first preliminary stage, acid pre-extraction of flocculated, de-oiled proteinaceous seeds takes place in an aqueous solution with a pH value of between 4 and 5. Then the protein extraction takes place in the aqueous system at a pH value of between 6 and 8, the solid content being between 1 and 10% by weight. In a further method step, the fractionation of the extract or of the diluted, regenerated protein takes place by means of a centrifuge, a separator or a decanter. The cross-linking is then carried out over a period of approximately 2 hours at a temperature of 40° C. with 1% by weight transglutaminase, in relation to the protein content, roughly 1% by weight sodium chloride being added also. Subsequent heating of the cross-linked product serves inactivation in order to guarantee that the product can be used without any objection in terms of food regulations.

The protein gel cross-linked in this manner has a gel strength which is above 1.5 to 1.8 N/cm². It is known that a gel which has a gel strength of more than 1.5 N/cm² is cut-resistant. The gel according to the invention is composed of 95-92% by weight water, 0-3% by weight sodium chloride and 3-5% by weight protein extract. Here the proportion of the protein in the protein extract is more than 90% by weight, in relation to the dry substance.

1. A method for producing transglutaminase-cross-linked proteins of vegetable origin, comprising:
a) fractionation of at least one of: a protein extract, protein curd, protein concentrate, protein hydrolysate and a protein isolate by centrifugation and/or ultrafiltration and/or regeneration; as well as
b) isolation of the protein fraction with a dry mass in the range between 1 and 10% by weight; and
c) cross-linking with transglutaminase at a temperature of between 0 and 60° C. and a mass ratio of between 0.01 and 10%.

2. The method according to claim 1, wherein the protein extract is produced from proteinaceous and oleaginous seeds before the fractionation.

3. The method according to claim 1, comprising drying the protein extract is dried after the isolation.

4. The method according to claim 3, comprising dissolving the protein extract, after drying, in an aqueous solution.

5. The method according to claim 1, wherein the fractionation takes place by centrifugation in an aqueous system.

6. The method according to claim 1, wherein the cross-linking with the transglutaminase takes place at a temperature of between 30 and 50° C.

7. The method according to claim 1, wherein the cross-linking with the transglutaminase takes place at a pH value of the solution of between 4 and 9.

8. The method according to claim 1, wherein for the cross-linking with the transglutaminase, the protein extract has a dry mass in the range between 3 and 5% by weight.

9. A protein gel produced by the method according to claim 1, wherein the protein content is between 1 and 18% by weight.

10. The protein gel according to claim 9, wherein the protein content is between 1.5 and 5% by weight and the protein gel has a cut-resistant consistency with a gel strength of between 1.5 and 8 N/cm².

11. The protein gel according to claim 9, characterised in that wherein the protein content is between 10 and 18% by weight and the protein gel has a bite-resistant consistency with a gel strength of more than 8 N/cm².

12. The protein gel according to claim 9, wherein in the dried state it has a water-binding capacity of between 5 and 20 mL/g.

13. The protein gel according to claim 9, wherein the protein gel retains the gel structure at a temperature treatment of up to 120° C.

14. Method of utilizing the protein gel according to claim 9 for the production and/or processing of food.

15. The method according to claim 4, wherein the aqueous solution comprises one of: water, a buffering solution and saline.
